(19) United States
(12) Patent Application Publication
(10) Pub. No.: US 2005/0269255 A1
(43) Pub. Date: Dec. 8, 2005

(54) Shaped flow distribution in filtration cassettes

(76) Inventor: Attila Herczeg, Southborough, MA (US)

Correspondence Address: AMERSHAM BIOSCIENCES;PATENT DEPARTMENT, 800 CENTENNIAL AVENUE, PISCATAWAY, NJ, 08855, US

(21) Appl. No.: 10/511,695

(22) PCT Filed: Jan. 14, 2003
(86) PCT No.: PCT/US03/01268

§ 371 Date: Jul. 1, 2005

Related U.S. Application Data
(60) Provisional application No. 60/373,983, filed on Apr. 19, 2002.
(60) Provisional application No. 60/425,199, filed on Nov. 8, 2002.

(51) Int. Cl. B01D 63/08

(52) U.S. Cl. 210/321.71; 210/321.75; 210/490; 210/321.61

(57) ABSTRACT

The present invention improves the flow dynamics about the leading edges of the sealed apertures within a filtration cassette by flowing a sealing resin so that it protrudes into the main passageway defined by the porous screens thereof. The sealing resin defines at least an end portion of a fluid channel in each passageway. Desirably, the sealing resin extends into the passageway so as to significantly reduce or eliminate the formation of he non-uniformities in fluid flow therethrough. The porous mesh may define apertures shaped so as to direct the resin during vacuum drawing to a desired location in the flow channels. The porous mesh may further include a shaped perimetrical edge which also assists in the drawing of a flowable resin into the porous mesh to further define the flow channels so as to significantly reduce or eliminate the formation on non-uniformities in the fluid flow.

### FIELD OF THE INVENTION

The present invention relates generally to the field of filtration devices. More specifically, the present invention relates to a filtration cassette having shaped flow distribution.

### BACKGROUND OF THE INVENTION

Cassette filtration devices have become the standard in many high technology filter applications such as in biopharmaceutical processing, virus removal from blood products, as well as water purification. Cassette filters are well known in the art and typically include a number of filter elements selectively bound together with a flowable resin so as to define internal channels for the distribution of feed, filtrate, and retentate streams therethrough. Typically, the channels are polymer based screens or plates with the appropriate openings that serve to space the filter elements from each other. The use of polymer screens in the formation of distribution layers provides a high degree of flow uniformity as well as good control of the shear imparted to the fluids. Examples of prior art filtration cassettes are provided by U.S. Pat. No. 4,715,955 to Friedman and U.S. Pat. No. 5,866,930 to Kopf, the teachings of which are incorporated by reference herein.

Typical cassette manufacture involves first cutting each of the flow screens and the filtration membranes into the shape of the cassette. Filtrate and retentate subassemblies are made in which flow is blocked by drawing a flowable resin about certain holes cut in the elements. Filtrate screen subassemblies include an elongate planar filtrate screen having a filter membrane positioned over each major surface. Each of these members of the filtrate screen subassemblies defines registered apertures for conducting either feed fluid, filtrate fluid, or retentate fluid through the assembled cassette. In the case of filtrate screen subassemblies, apertures utilized in the distribution of feed and retentate streams are blocked with the resin so as to allow those streams to pass therethrough without access to the filtrate screen. The feed and retentate subassemblies, each composes of only a single feed or retentate screen, include similarly registered apertures for mating with the filtrate subassemblies. In the feed and retentate subassemblies, the holes utilized for the distribution of filtrate streams are perimetrically sealed with the flowable resin so as to prevent mixing with the feed/retentate streams. The result of stacking these subassemblies is a filtration cassette having a plurality of holes therethrough for accommodating the separation of the filtrate streams from the feed and retentate streams. The stack of these subassemblies are also perimetrically sealed with a flowable resin to provide the mechanical integrity and to completely define all of the flow channels necessary for operation.

The application of the flowable resin in each of these steps is accomplished in three steps. First, a number of feed/retentate screens are stacked in a mold with an impermeable spacer placed between each screen. The flowable resin is injected into each elongate cavity formed by the overlying filtrate apertures. The mold is then closed about the stack of screens and a vacuum is applied to the mold cavity so as to draw the resin into the screens sufficiently to form a fluid-tight gasketing seal about those apertures. Second, a number of filtrate subassemblies are stacked in a mold with an impermeable spacer layer placed between adjacent subassemblies. The flowable resin is injected into each elongate cavity formed by the overlying feed and retentate apertures. The mold is closed about the stacked subassemblies and a vacuum is applied to the mold cavity to draw the resin into the screens sufficiently to form a fluid-tight seal about those apertures. Upon the resin hardening, the screen and an overlying and underlying filter medium, are permanently joined about the feed/retentate apertures. Third, the final encapsulation step of the entire cassette requires all of the subassemblies to be appropriately stacked and the resin introduced around the periphery of the assembly. Again, a vacuum is drawn on the interior of the assembly through the all of the apertures and the resin is drawn into the perimeter of the parts, thereby binding the stack permanently.

FIGS. 1 and 2 depict the general structure and operation of a filtration cassette 10. Cassette 10 includes a housing 12 surrounding an assembly 14 of a first and second impermeable film 16 and 18, first and second feed/retentate subassemblies 17 and 19, and filtrate subassembly 25. Feed/retentate subassemblies 17 and 19 include an elongate planar porous mesh or screen 20 and 22, respectively, which incorporate gaskets 21 for directing two flow streams therethrough. Feed/retentate screens 20 and 22 define first and second elongate feed/retentate passageways 30 and 32, respectively, as well as feed/retentate ports 36 and 38 and filtrate ports 40 and 42. Filtrate subassembly 25 includes a first and second filter membrane 24 and 26 partially attached to a filtrate screen 28. Filtrate screen 28 defines an elongate filtrate passageway 34 while filtrate screen 28 and filter membranes 24 and 26 define both first and second feed/retentate ports 36 and 38 and first and second filtrate ports 40 and 42. Subassembly 25 includes gaskets 31 which isolate feed/retentate ports 36 and 28 from filtrate passageway 34. Gaskets 31 further serve to bond filter membranes 24 and 26 to filtrate screen 28. Subassemblies 17, 19, and 25 thereby define registered apertures comprising first and second feed/retentate ports 36 and 38 extending in fluid communication with feed/retentate passageways 30 and 32 and registered apertures comprising first and second filtrate ports 40 and 42 extending in fluid communication with filtrate passageway 34. Gaskets 21 and 31 serve to isolate the feed/retentate stream from the filtrate steam of cassette 10. Filter membranes 24 and 26 allow the filtrate component of the feed stream to pass from feed/retentate passageways 30 and 32 into filtrate passageway 34. Filter membranes 24 and 26 are desirably selected from the group comprising ultrafiltration flat sheet membranes, microfiltration flat sheet membranes and may optionally be selected to be either asymmetric or symmetric membranes as are known in the art. Impermeable films 16 and 18 are also optionally discarded from cassette 10.

As is demonstrated by FIG. 2, feed fluid may be provided through port 36, traversing through passageways 30 and 32, and exiting as retentate fluid through port 38. Cross-flow filtration occurs as the filtrate component of the feed fluid passing through feed/retentate passageways 30 or 32 then traverses through filter membranes 24 and 26, into filtrate passageway 34 and out filtrate ports 40 and 42. Cleaning cassette 10 of entrapped material may be performed by reversing flow across filter membranes 24 and 26 and collecting the entrapped material outside either or both of the feed/retentate ports 36 and 38.

One deficiency in many filtration devices, including cassette filters, is the creation of ‘dead spots’ or other flow non-uniformities. FIG. 3 depicts the fluid flow through a multi-apertured feed/retentate screen 50. Screen 50 defines a feed/retentate passageway 52 extending between a plurality of longitudinally-aligned first and second feed/retentate apertures 54 and 56. Screen 50 also defines a plurality of longitudinally-aligned filtrate apertures 58 and 60. As screen 50 provides for flow of feed/retentate fluid, screen 50 includes both a perimetrical seal 62 and contamination-blocking seals 64 about each of fitlrate apertures 58 and 60. As shown in FIG. 3, the flow patterns across passageway 52 will develop dead spots 66, or areas of non-uniform flow, where collected material will accumulate due to the low shear provided by either normal or reverse flow.

FIG. 4 depicts the fluid flow through a multi-apertured filtrate screen 70 according to the prior art. Screen 70 defines a filtrate passageway 72 extending between a plurality of transversely-offset first and second feed/retentate apertures 74 and 76. Screen 70 also defines a plurality of transversely-offset filtrate apertures 78 and 80. As screen 70 provides for flow of feed/retentate fluid, screen 70 includes both a perimetrical seal 82 and contamination-blocking seals 84 about each of fitlrate apertures 78 and 80. As shown in FIG. 4, the flow patterns across passageway 72 will develop dead spots 86, or areas of non-uniform flow, where collected material will accumulate due to the low shear provided by either normal or reverse flow.

Non-uniform flow can create several problems for utilization of the filter, including accumulation of filtered debris in the areas of low shear resulting in, e.g., incomplete cross-flow cleaning action. This accumulation in turn creates problems cleaning the filtration cassette between uses as low shear areas are not evenly exposed to cleaning action. This phenomenon results in incomplete utilization of the membrane area as well as contamination from one use to the next due to the poor cleaning. Additionally, in some applications, the entrapped accumulation may represent the material of value to be collected from the filtration cassette. Such entrapped material would be lost to the user.

Several areas of a filtration cassette are subject to lower flow due to fluid dynamics within the channels for distribution of the various streams. It has been seen that the most pronounced problems occur within the feed layer, including areas adjacent the corners of the layers as well as near the seals of manifold holes corresponding to the filtrate distribution.

### SUMMARY OF THE INVENTION

The present invention overcomes the deficiencies in the prior art filtration cassettes by providing a filtration cassette having shaped flowpaths to minimize, if not eliminate, the occurrence of dead spots therein. The present invention contemplates that the flowpaths may be shaped at their opposing ends or for up to their entire length between the flowports.

The cassettes of the present invention may be formed to include alternating layers of filtration media and porous screens. Each porous screen defines either a feed/retentate passageway or a filtrate passageway. The filtration media and porous screens each define a plurality of feed/retentate apertures and filtrate apertures to be positioned in respective overlying registry so as to be in unobstructed fluid communication with the feed/retentate passageway and the filtrate passageway, respectively. A sealing resin is provided to perimetrically seal the edges of the filtration media and the porous mesh as well as to seal the apertures defined thereby so as to render the feed/retentate passageways in obstructed fluid communication with the filtrate passageways only through the filter media. The sealing resin defines at least an end portion of a fluid channel in each passageway.

The present invention improves the flow dynamics about the leading edges of the sealed apertures by flowing the sealing resin so that it protrudes into the main passageway defined by the screens. Desirably, the sealing resin extends into the passageways so as to significantly reduce or eliminate the formation of non-uniformities in fluid flow therethrough. The porous mesh may define apertures shaped so as to direct the resin during vacuum drawing to a desired location in the flow channels. The sealing resin may be flowed from either the outside edge of the porous screens towards the flowpath, from the interior ports in the screen towards the interior and edges of the screen, or a combination of both. The porous mesh may further include a shaped perimetrical edge which also assists in the drawing of a flowable resin into the porous mesh to further define the flow channels so as to significantly reduce or eliminate the formation of non-uniformities in the fluid flow.

It is further contemplated by the present invention that the flowpaths may be formed by stamping shaped gaskets which may be combined with the screens so as to form shaped flowpaths which minimize or altogether prevent the formation of deadspots.

### BRIEF DESCRIPTION OF THE DRAWINGS

FIG. 1 depicts an partially exploded view of a typical filtration cassette assembly of the prior art so as to demonstrate routine fluid flow therethough.

FIG. 2 is a cross-sectional view of the cassette of FIG. 1 taken through the line 2-2 so as to demonstrate fluid flow therethrough.

FIG. 3 depicts an elevational view of a porous screen of a filtration cassette assembly of the prior art showing the location of flow non-uniformities.

FIG. 4 depicts an elevational view of a porous screen of a filtration cassette assembly of the prior art showing the location of flow non-uniformities.

FIG. 5 depicts an elevational view of a porous feed/retentate screen of a filtration cassette assembly of the present invention.

FIG. 6 depicts an elevational view of a porous filtrate screen of a filtration cassette assembly of the present invention.

FIG. 7 depicts various manifold aperture geometries contemplated by the present invention.

FIGS. 8 and 9 depict alternate embodiments of a feed/retentate screen die of the present invention.

FIG. 10 depicts a feed/retentate screen of the either FIG. 8 or 9 sealed for use in a feed/retentate subassembly of the present invention.

FIGS. 11 and 12 depict alternate embodiments of a filtrate screen die of the present invention.

FIG. 13 depicts a filtrate screen of the either FIG. 11 or 12 sealed for use in a filtrate subassembly of the present invention.

FIG. 14 depicts another screen for use in a filter cassette of the prior art.

FIG. 15 depict the screen of FIG. 14 sealed for use in a filtrate subassembly of the prior art.

FIG. 16 depict the screen of FIG. 14 sealed for use in a feed/retentate subassembly of the prior art.

FIG. 17 depicts a feed/retentate screen die of the present invention.

FIG. 18 depicts the feed/retentate screen die of FIG. 17 sealed for use in a feed/retentate subassembly of the present invention.

FIG. 19 depicts a filtrate screen die of the present invention.

FIG. 20 depicts the filtrate screen die of FIG. 19 sealed for use in a filtrate subassembly of the present invention.

FIG. 21 depicts yet another screen for use in a filter cassette of the prior art.

FIG. 22 depict the screen of FIG. 21 sealed for use in a feed/retentate subassembly of the prior art.

FIG. 23 depict the screen of FIG. 21 sealed for use in a filtrate subassembly of the prior art.

FIGS. 24 and 25 depict still other alternate embodiments of a filtrate screen die of the present invention.

FIG. 26 depicts a filtrate screen of the either FIG. 24 or 25 sealed for use in a filtrate subassembly of the present invention.

FIGS. 27 and 28 depict still other alternate embodiments of a feed/retentate screen die of the present invention.

FIG. 29 depicts a feed/retentate screen of the either FIG. 8 or 9 sealed for use in a feed/retentate subassembly of the present invention.

FIG. 30 depicts even still another filtration cassette of the present invention.

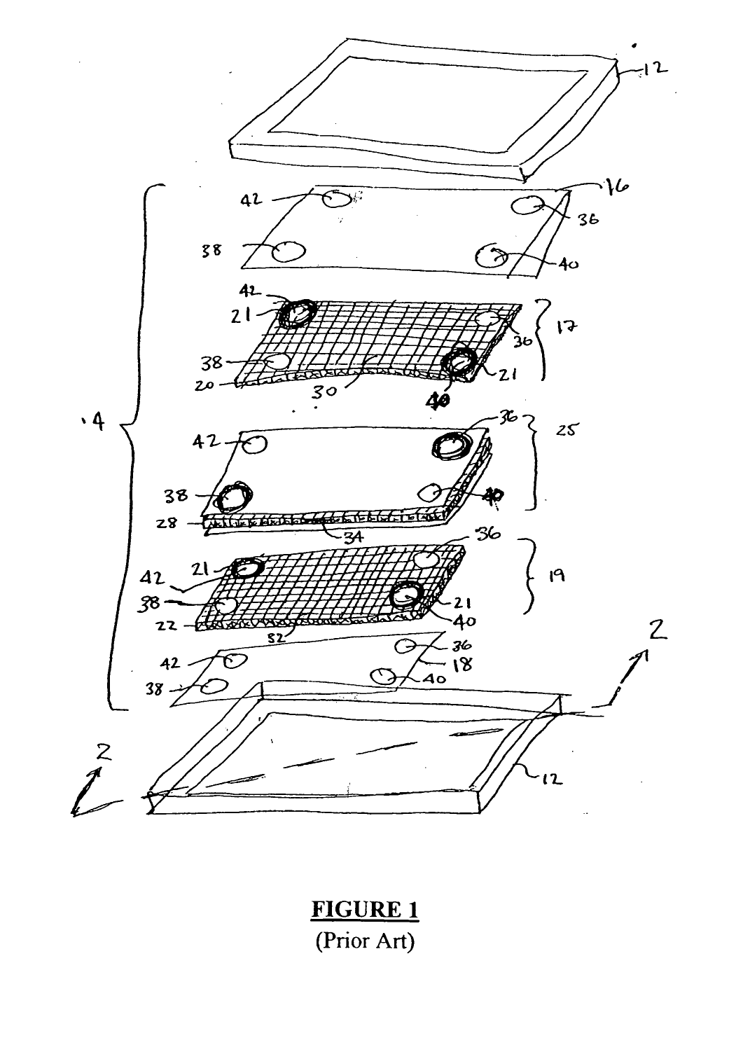

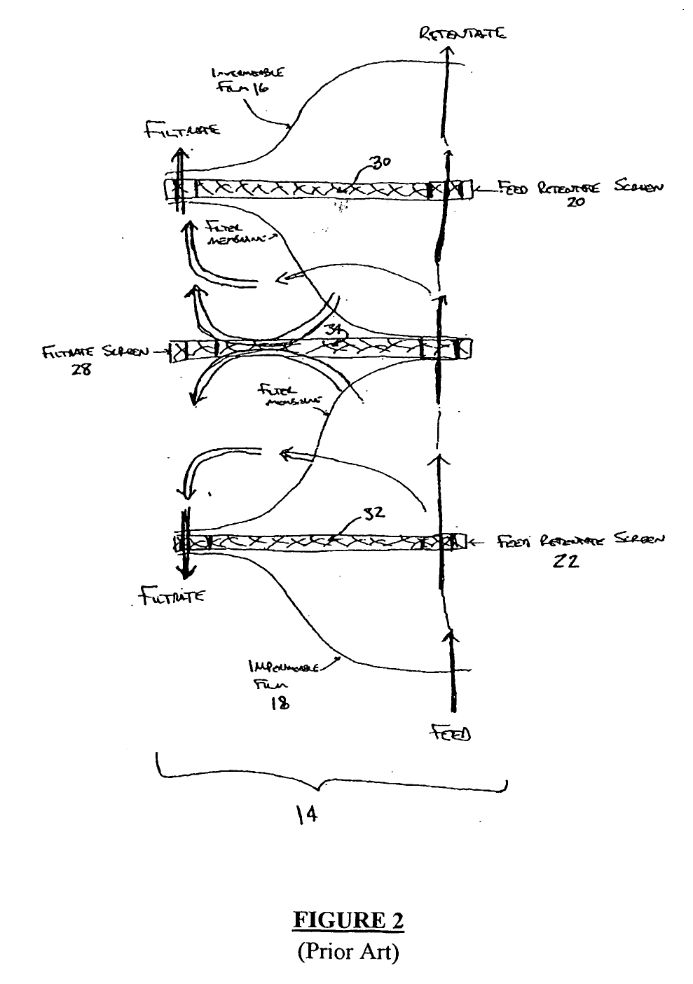

### DETAILED DESCRIPTION OF THE PREFERRED EMBODIMENTS

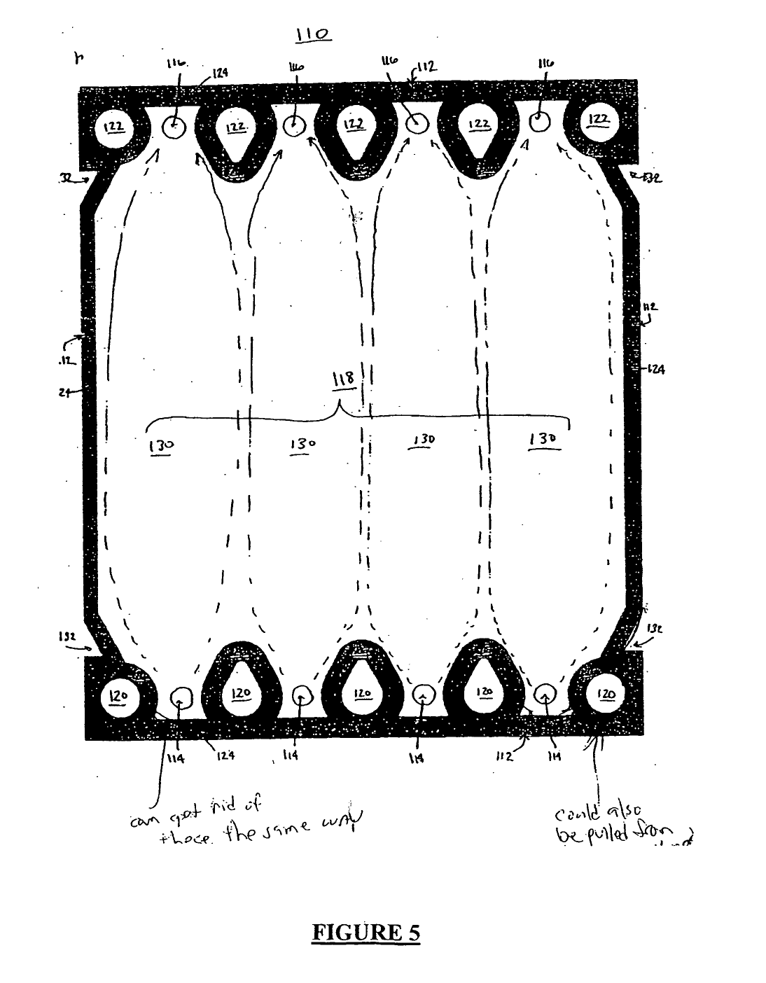

FIG. 5 depicts an elongate porous feed/retentate screen 110 of the present invention and is desirably be incorporated into a filtration cassette between opposing filter membranes or between a filter membrane and an impervious film. Screen 110 is desirably formed of a suitable material for filtration applications and is typically formed from a polymeric or metal mesh which permits fluid flow across its length. Screen 110 includes a perimetrical edge 112 and defines a plurality of longitudinally-opposed first and second filtrate apertures 114 and 116 as is known in the art. Screen 110 defines an elongate filtrate passageway 118 extending between first and second filtrate apertures 114 and 116. Filtrate apertures 114 and 116 are shown as being circular in shape. Screen 110 also defines a plurality of longitudinally-opposed feed/retentate apertures 120 and 122. Perimetrical seal 124 bounds passageway 118. Feed/retentate apertures 120 and 122 are bound by aperture seals 126 which extend into passageway 118 so as to define a plurality of filtrate channels 130 exhibiting uniform flow without dead spots near the seals.

Aperture seals 126 desirably include converging/diverging edges 126a and 126b so as to effect a tapering shape to the opposed ends of channels 130. Edges 126a and 126b are desirably oriented in a non-perpendicular manner to edges 112a and 112b so that the seal occupies the area where dead spots might otherwise form. It is contemplated that apertures seals 126 may be shaped to direct the flow of fluid towards or away from the adjacent open apertures.

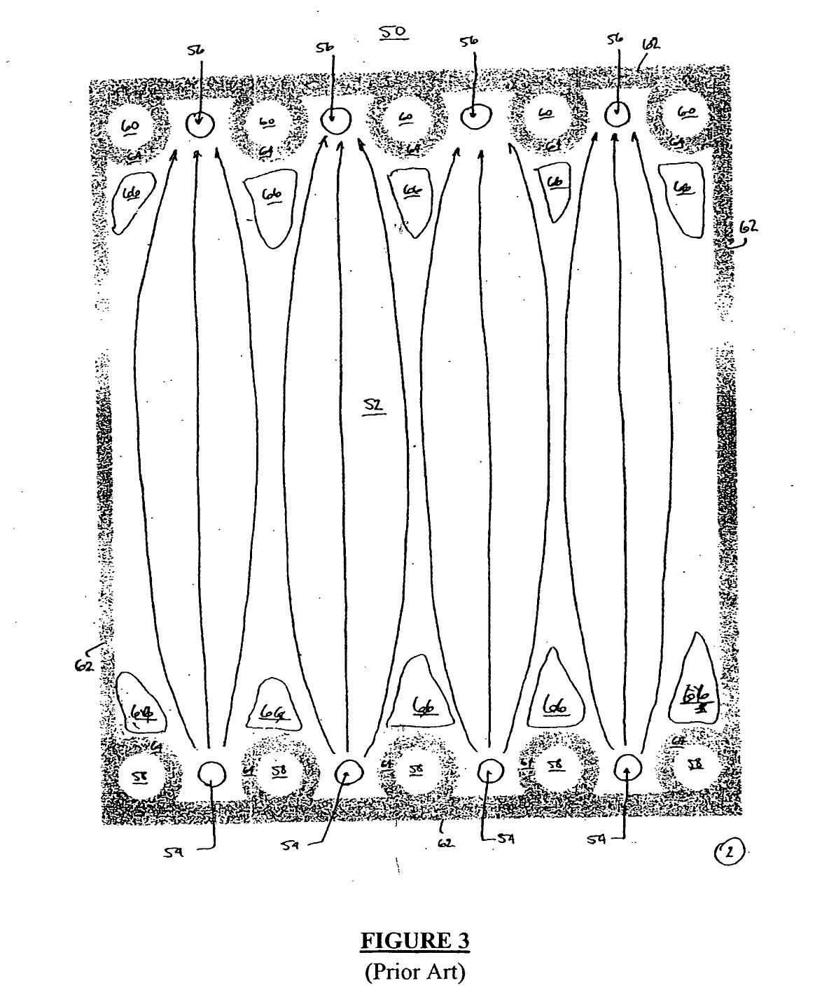

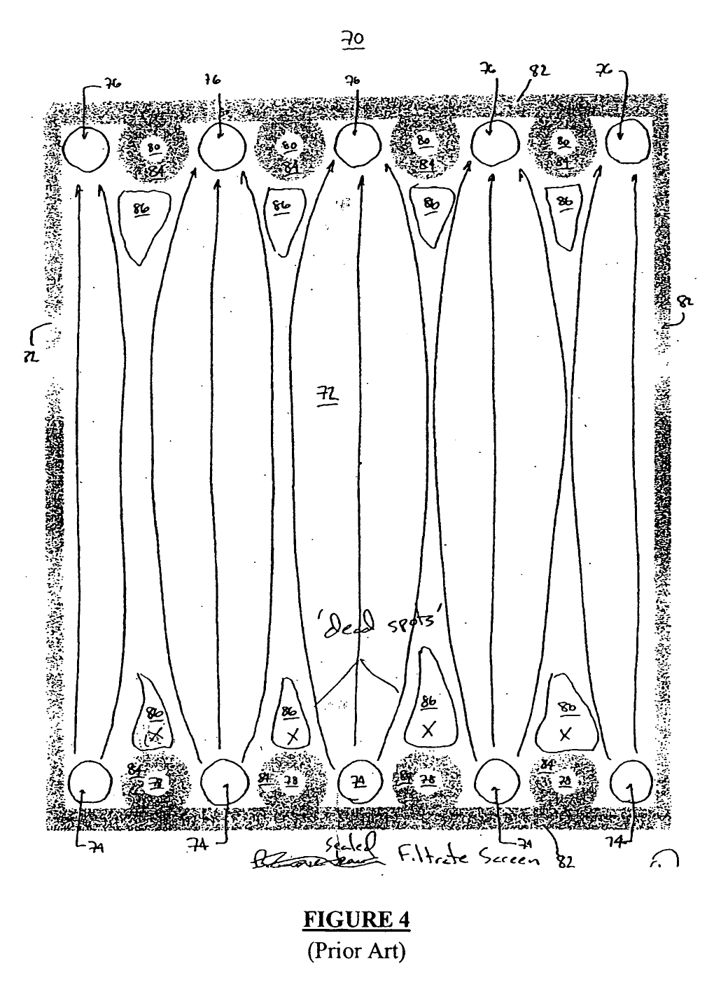

The shape of aperture seals 126 can be provided by shaping the feed/retentate apertures 120 and 122 defined by screen 110 to include a protrusion towards filtrate passageway 118. As the flowable resin is drawn into the screen from each of the feed/retentate apertures 120 and 122, the shape of seals 126 is attained. The present invention contemplates that the shape of the seals about the apertures in the screens will be related to the shape of the aperture about which it is created. As seen in FIGS. 3 and 4, the shape of the seal about a round aperture of the prior art will simply be an annular circle of larger diameter. The present invention contemplates shaping the aperture such that the shape of the seal formed thereabout minimizes or eliminates the dead spots adjacent those seals.

The present invention further contemplates that the perimetrical edge 124 of screen 110 may be shaped so as to further eliminate dead spots occurring near the corners of the filtrate screens. Due to the lower flowrates at these corner areas, these portions of screen 110 are similarly under-utilized. In addition, the lack of flow leads to the accumulation of debris as was described about the apertures. By suitably shaping the screen used in the filter assembly, the present invention further contemplates that these dead spots may be eliminated during the final sealing step, as the flowable resin is drawn into the outer perimeter of each of the filter elements. As seen in FIG. 5, screen 110 further defines notches 132 in the proximity of the corners thereof to allow the resin to proceed further into screen 110 about that location as the resin is either drawn from edge 124 or from apertures 120 and 122. The lower flow charactertics associated with the corners may thereby be obviated.

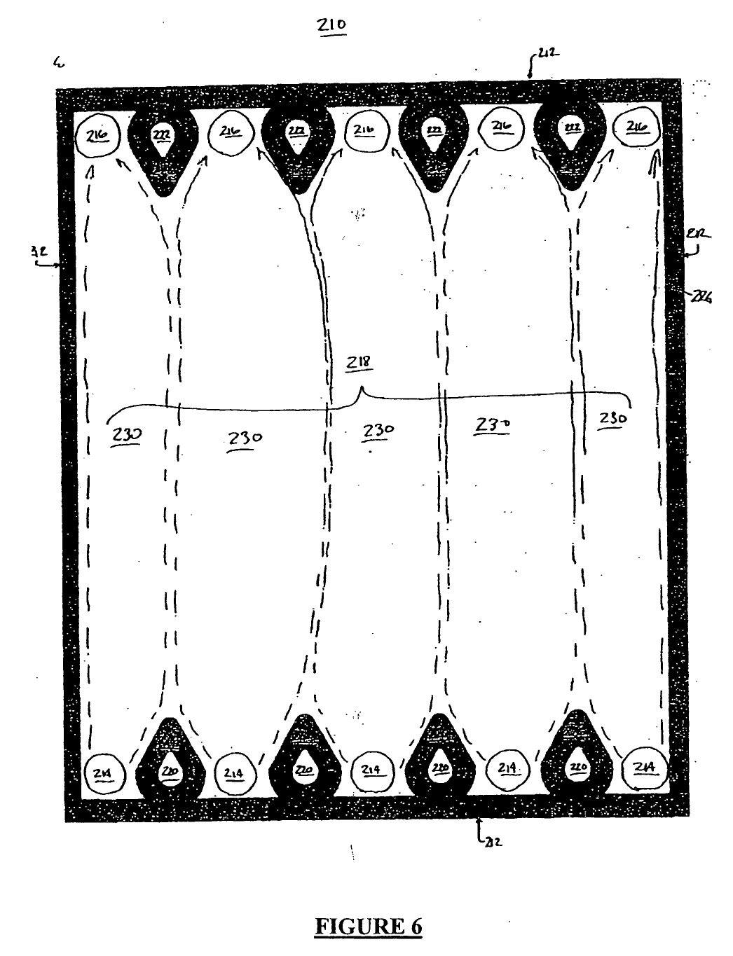

FIG. 6 depicts a feed/retentate_screen 210 of the present invention. feed/retentate_screen 210 is designed to be incorporated into a filter assembly with filtrate screen 110 and is desirably positioned between opposing filter membranes or between a filter membrane and an impervious film. Filtrate screen 210 incorporates a shaped perimetrical edge 212 similar to filtrate screen 110. Feed/retentate screen 210 further defines longitudinally-opposed feed/retentate apertures 214 and 2 16 as well as an elongate feed/retentate_passageway 218 extending therebetween. Filtrate screen 210 also defines longitudinally-opposed filtrate apertures 220 and 222 alternating between feed/retentate apertures 214 and 216, respectively. Perimetrical seal 224 bounds passageway 218. Filtrate apertures 214 and 216 are bounded by aperture seals 226 which extend into passageway 218 so as to define a plurality of filtrate channels 230 exhibiting uniform flow without dead spots near the seals. Seals 226 prevent contamination of the feed/retentate streams with the filtrate streams within the assembled filter cassette.

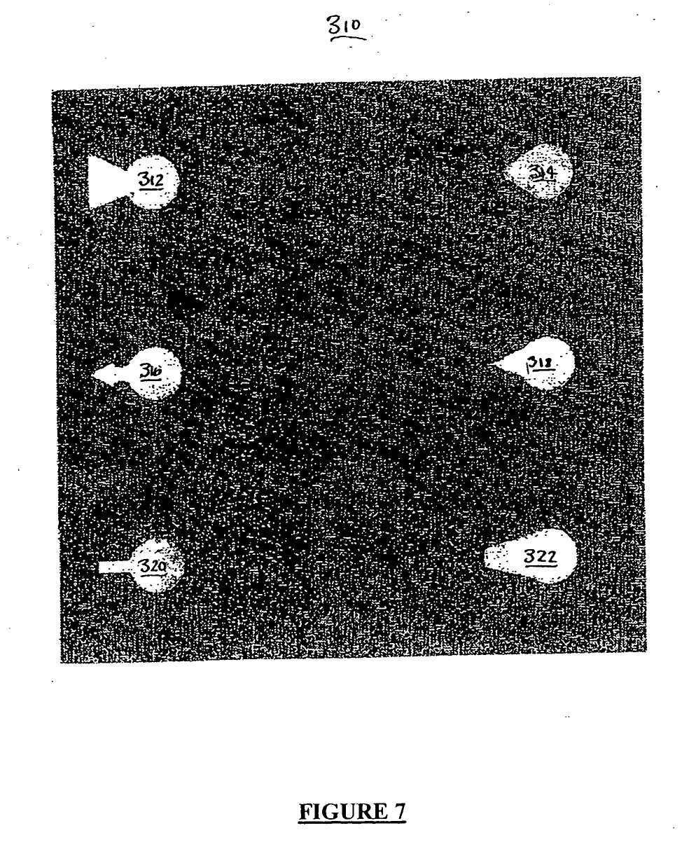

FIG. 7 depicts a screen 310 defining a variety of aperture shapes contemplated for providing the shaped seals of the present invention. Apertures 312, 314, 316, 318, 320, and 322 each are shown to be symmetrical only about the longitudinal axis of the screen so as to extend towards the passageway defined by the screen. Each of the apertures are desirably shaped so as to allow the resin sealant to flow into the screens and provide tapering ends to the flow channels formed. Each end of the flow channels are desirably shaped in a manner which significantly reduces or eliminates the formations of the dead spots in therein. The present invention further contemplates that additional shapes for the apertures may be defined by the screens including, by way of illustration and not of limitation, totally non-symmetric shapes, shapes symmetric about three axes, as well as others which will be obvious to one of ordinary skill in this art. Additionally, the present invention contemplates that the opposed feed/retentate and filtrate apertures defined by the screens may be transversely off-set rather than longitudinally-aligned. Moreover, the present invention contemplates that the shapes of the apertures and the longitudinally opposed ends of the screens may be cooperatively shaped so as to significantly reduce or, alternatively, eliminate the formation of dead spots in the fluid channels of the passageways of a filter cassette.

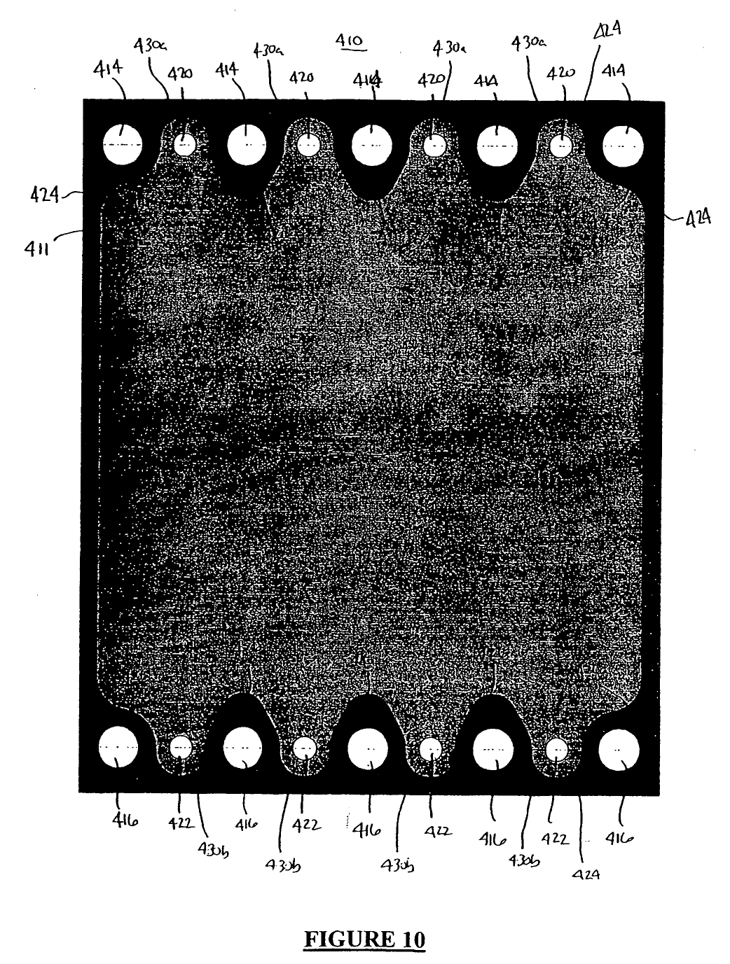

FIG. 10 depicts another embodiment of a sealed filtrate screen 410 for use in a filtrate subassembly of the present invention. Sealed filtrate screen 410 is formed by a screen die 411 and a perimetrical seal 424. Filtrate screen 410 defines longitudinally-opposed feed/retentate apertures 414 and 416. Filtrate screen 410 also defines longitudinally-opposed filtrate apertures 420 and 422 alternating between feed/retentate apertures 414 and 416, respectively. Filtrate screen 410 further defines an elongate filtrate passageway 418 extending between filtrate apertures 420 and 422. Perimetrical seal 424 bounds passageway 418 and includes a number of aperture seals 426 bounding feed/retentate apertures 414 and 416. Aperture seals 426 extend into passageway 418 so as to define a plurality of feed/retentate channels 430 exhibiting uniform flow without dead spots near the seals. Aperture seals 426 further define smoothly tapered ends 430a and 430b for the feed/retentate channels 430 so as to further minimize the formation of deadspots in the cassette in the vicinity of apertures 414 and 416. Ends 430a and 430b of channels 430 are desirably shaped to closely conform about filtrate apertures 420 and 422, respectively.

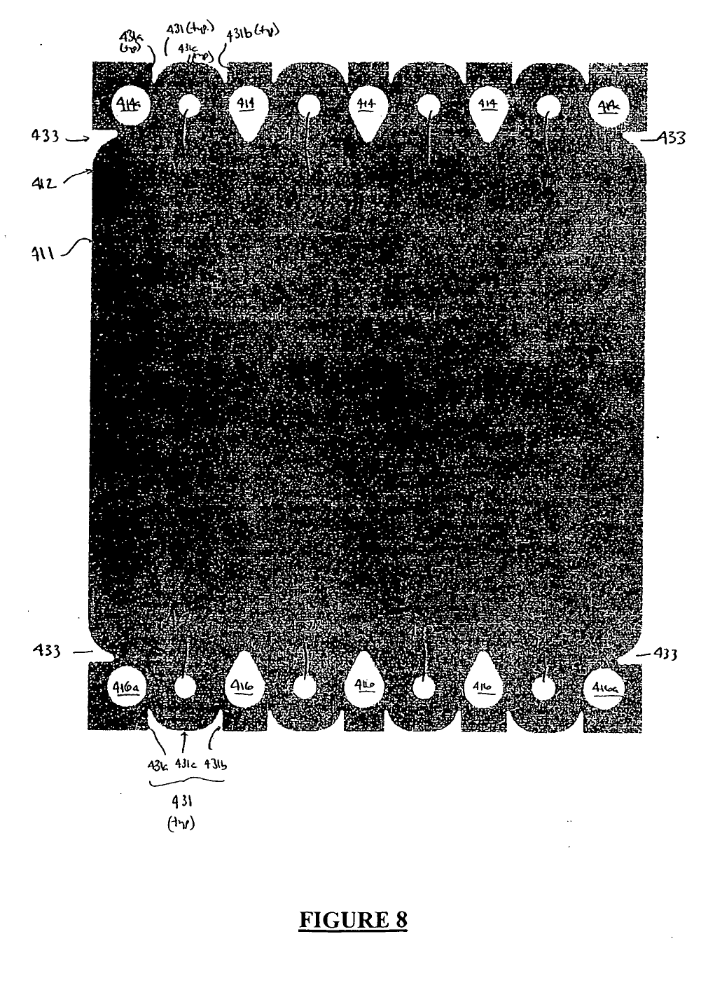

FIG. 8 depicts a first embodiment of a filtrate screen die 411 useful for forming sealed filtrate screen 410. Filtrate screen die 411 incorporates a shaped perimetrical edge 412 and shaped feed/retentate apertures 414 and 416 to assist in the formation of seals 424 and 426 about feed/retentate apertures 414 and 416. Corner feed/retentate apertures 414a and 416a are circular in shape as shaped edge 412 induces formation of aperture seals 426 thereabout. Shaped edge 412 defines a number of outwardly-opening notches 431 at a location adjacent filtrate apertures 420 and 422. Each notch 431 includes a pair of opposing longitudinal edges 431a and 431b and an arcuate edge 431c which generally conforms about the adjacent filtrate aperture 420 or 422, as appropriate. Notches 431 allow sealant material to be drawn towards filtrate apertures 420 and 422 so as to thwart the formation of deadspots between the filtrate apertures and perimetrical seal 424. Shaped edge 412 also defines transversely-opening notches 433 adjacent corner feed/retentate apertures 424a and 426a to allow the sealant material to be drawn into filtrate passageway 418 and thereby provide a tapering leading edge 426a extending from perimetrical seal 424. Shaped feed/retentate apertures 414 and 416 may be shaped in accordance with the teachings herein so as to shape aperture seals 426 to extend into filtrate passageway 418 and thwart the formation of deadspots in filtrate flow.

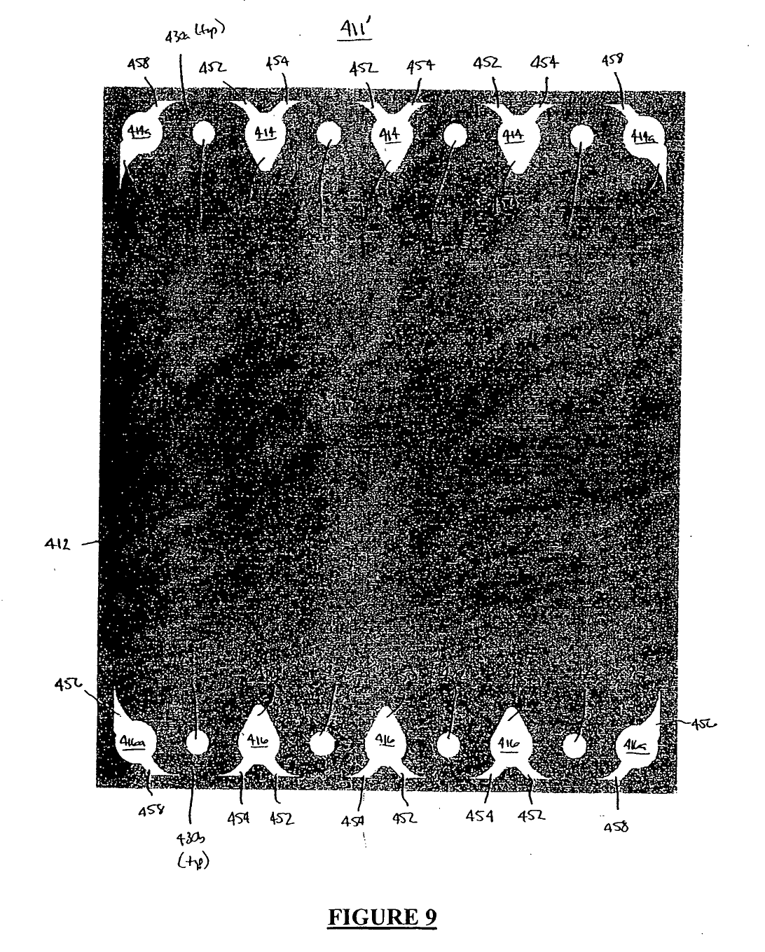

FIG. 9 depicts a second filtrate screen die 411′ useful for forming sealed filtrate screen 410. Screen die 411′ defines feed/retentate apertures 414 and 416, filtrate passageway 418, and filtrate apertures 420 and 422. Screen die 411′ imparts the desired shapes to perimetrical seal 424 and aperture seals 426 solely by shaping central feed/retentate apertures 414 and 416 and corner feed/retentate apertures 414a and 416a. Corner feed/retentate apertures 414a and 416a incorporate different shapes than the central feed/retentate apertures 414 and 416 so as to provide a tapering leading edge extending into filtrate passageway 418 from perimetrical edge 424. Central feed/retentate apertures 414 and 416 are elongate apertures including wedge-shaped portions 450 extending towards filtrate passageway 418 and opposed first and second leg portions 452 and 454 extending both about one of the adjacent filtrate apertures 420 and 422. Portion 450 will provide for the tapering leading edge of aperture seals 426 while portions 452 and 454 wil provide the tapering shape of passageway ends 430a or 430b. Corner feed/retentate apertures 414a and 416a are asymmetrically-shaped so as to provide for formation of aperture seal portion 246a. Corner feed/retentate apertures 414a and 416a include a wedge portion 456 obliquely extending towards passageway 418 and the adjacent edge 412 and a leg portion 458 obliquely extending about the adjacent filtrate aperture 420 or 422. Portions 456 and 458 extend substantially diagonally opposed from their respective corner apertures.

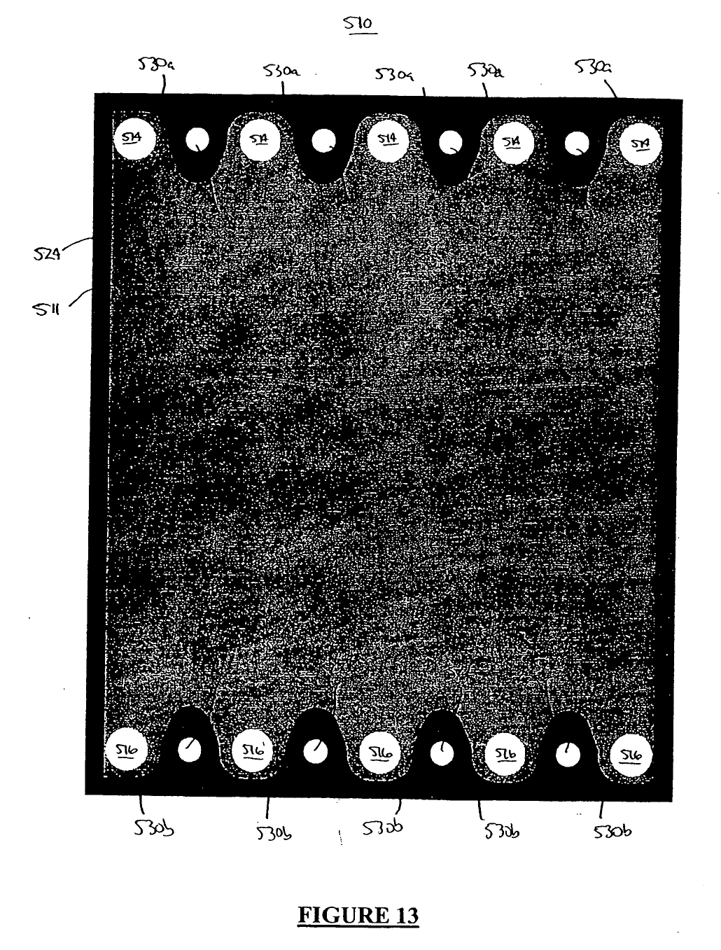

FIG. 13 depicts another embodiment of a sealed feed/retentate screen 510 for use in a feed/retentate subassembly of the present invention. Sealed filtrate feed/retentate screen 510 is formed from an elongate porous screen 511 and perimetrical seal 524. Screen 511 defines longitudinally-opposed feed/retentate apertures 514 and 516. Filtrate screen 511 also defines longitudinally-opposed filtrate apertures 520 and 522 alternating between feed/retentate apertures 514 and 516, respectively. Feed/retentate screen 511 further defines an elongate filtrate passageway 518 extending between filtrate apertures 520 and 522. Perimetrical seal 524 bounds passageway 518. Feed/retentate apertures 514 and 516 are bounded by aperture seals 526 which extend into passageway 518 so as to define a plurality of feed/retentate channels 530 exhibiting uniform flow without dead spots near the seals. Aperture seals 526 further define a smoothly tapered ends 530a and 530b for the feed/retentate channels 530 so as to further minimize the formation of deadspots in the cassette. Ends 530a and 530b of channels 530 are desirably shaped to closely conform about the annular edge of filtrate apertures 520 and 522.

FIG. 11 depicts a first embodiment of a feed/retentate screen die 511 useful for forming sealed feed/retentate screen 510. Feed/retentate screen die 511 incorporates a shaped perimetrical edge 512, circular feed/retentate apertures 514 and 516, and shaped filtrate apertures 520 and 522 to assist in the formation of seals 524 and 526 thereabout. Shaped edge 512 defines a number of outwardly-opening notches 531 at a location adjacent feed/retentate apertures 514 and 516. Each notch 531 includes a pair of opposing longitudinal edges 531a and 531b and an arcuate edge 531c which generally conforms about the adjacent feed/retentate apertures 514 and 516, as appropriate. Notches 531 allow sealant material to be drawn towards feed/retentate apertures 514 and 516 so as to thwart the formation of deadspots between the feed/retentate apertures and perimetrical seal 524. Screen 511 also defines outwardly-opening notches 533a-d incorporating opposed linear edge 541 and arcuate edge 543 for accommodating sealant flow about the corner feed/retentate apertures. Shaped filtrate apertures 520 and 522 may be shaped in accordance with the teachings herein so as to cause aperture seals 526 to extend into feed/retentate passageway 518 and thwart the formation of deadspots in filtrate flow.

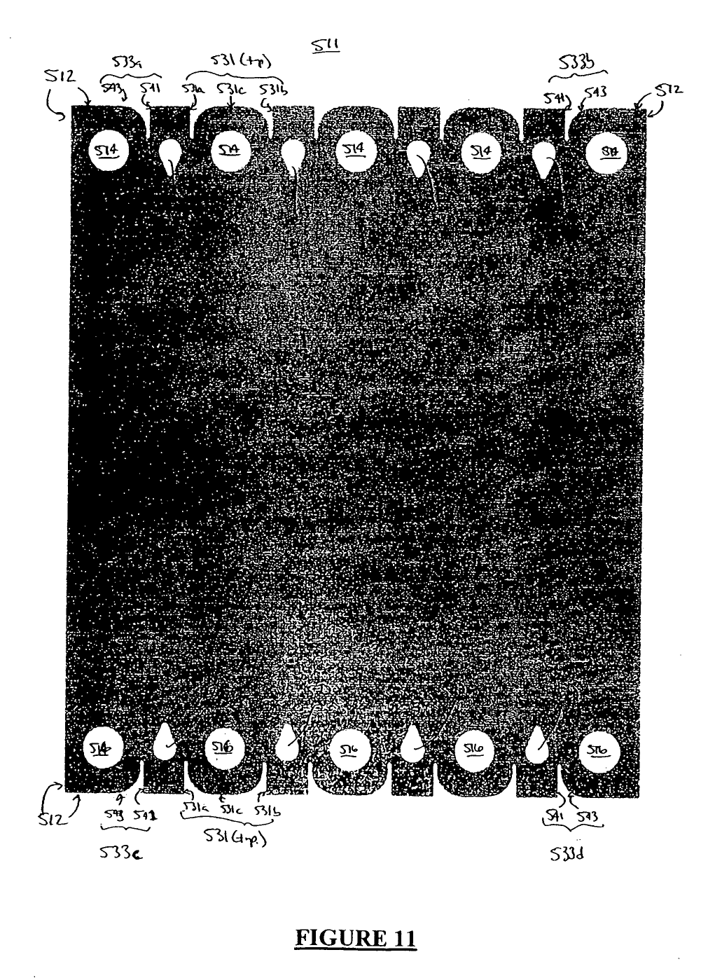

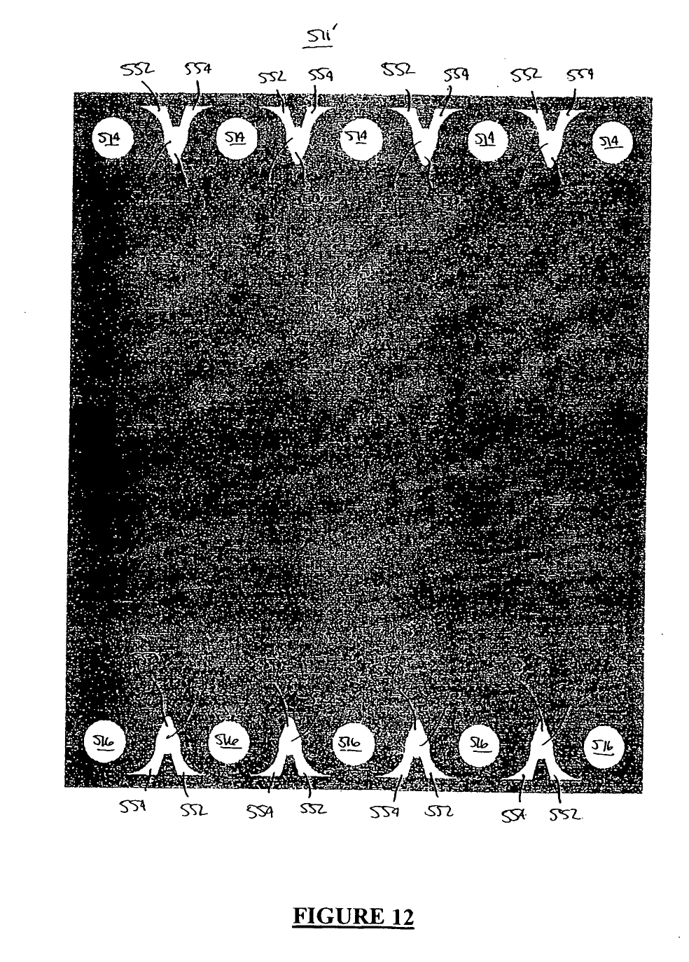

FIG. 12 depicts a second feed/retentate screen die 511′ useful for forming sealed feed/retentate screen 510. Screen die 511′ defines feed/retentate apertures 514 and 516, feed/retentate passageway 518, and filtrate apertures 520 and 522. Screen die 511′ imparts the desired shapes to perimetrical seal 524 and aperture seals 526 solely by shaping filtrate apertures 520 and 522. Filtrate apertures 520 and 522 are elongate apertures including wedge-shaped portions 550 extending towards feed/retentate passageway 518 and opposed first and second leg portions 552 and 554 extending each about one of the adjacent feed/retentate apertures 514 or 516. Portion 550 will provide for the tapering leading edge of aperture seals 526 while portions 552 and 554 provide the tapering shape of passageway ends 530a or 530b.

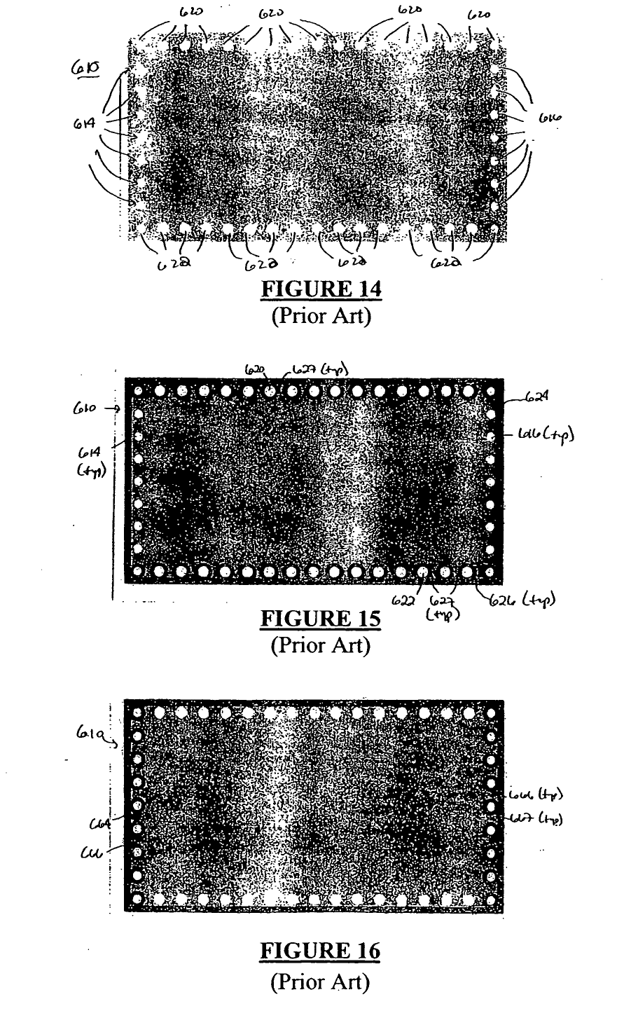

FIG. 14 depicts another screen 610 for use in a filter cassette of the prior art. Screen 610 is a porous and planar member defining rows of longitudinally opposed feed/retentate apertures 614 and 616 and transversely-opposed filtrate apertures 620 and 622. FIG. 15 depicts screen 610 of FIG. 14 sealed for use in a feed/retentate subassembly of the prior art. Screen 610 incorporates a perimetrical seal 624 and includes annular seals 626 about each of the filtrate apertures 620 and 622. Adjacent annular seals 626 define gaps 627 therebetween which are prone to forming as deadspots in which material may collect and be unretrievable by backflushing the finished cassette. Similarly, FIG. 16 depicts screen 610 of FIG. 14 sealed for use in a filtrate subassembly of the prior art. Screen 610 now incorporates a perimetrical seal 664 and includes annular seals 666 about each of the filtrate apertures 620 and 622. Adjacent annular seals 666 define gaps 667 therebetween which are prone to performing as deadspots in which material may collect and be unretrievable by backflushing the finished cassette.

FIG. 17 depicts yet another feed/retentate screen die 711 of the present invention. Screen 711 is a porous and planar member defining rows of longitudinally opposed feed/retentate apertures 714 and 716, transversely-opposed filtrate apertures 720 and 722, and an elongate feed/retentate passageway 718. Feed/retentate apertures 714 and 716 are formed to be circular in shape while filtrate apertures 720 and 722 include a circular portion 720a and 722a and oppositely-extending leg portions 720b and 720c and 722b and 722c, respectively. Leg portions 720b,720c and 722b, 722c are located between circular portions 720a and 722 feed/retentate passageway 718, respectively.

FIG. 18 depicts a sealed feed/retentate screen 710, incorporating the feed/retentate screen die 711, for use in a feed/retentate subassembly of the present invention. Feed/retenate screen 710 incorporates a perimetrical seal 724 and includes annular seals 726 about each of the filtrate apertures 720 and 722. Feed/retentate screen Adjacent annular seals 726 define gaps 727 therebetween. Feed/retentate screen 710 further includes blocking seal members 729 isolating gaps 727 from feed/retentate passageway 718. Blocking seal members 729 are formed from the sealant material being drawn into leg portions 720b and 720c and 722b and 722c of each filtrate aperture 720 and 722. Blocking seal members 729 thereby prevent gaps 727 from forming deadspots in the feed/retentate flow between apertures 714 and 716,

FIG. 19 depicts yet another filtrate screen die 811 of the present invention. Screen 811 is a porous and planar member defining rows of longitudinally opposed feed/retentate apertures 814 and 816, transversely-opposed filtrate apertures 820 and 822, and an elongate feed/retentate passageway 818. Filtrate apertures 820 and 822 are formed to be circular in shape while feed/retentate apertures 814 and 816 include a circular portion 814a and 816a and oppositely-extending leg portions 814b and 814c and 816b and 816c, respectively. Leg portions 814b and 814c and 816b and 816c are located between circular portions 814a and 816a and feed/retentate passageway 818, respectively.

FIG. 20 depicts a sealed filtrate screen 810, incorporating the filtrate screen die 811, for use in a feed/retentate subassembly of the present invention. Filtrate screen 810 incorporates a perimetrical seal 824 and includes annular seals 826 about each of the feed/retentate apertures 814 and 816. Adjacent annular seals 826 define gaps 827 therebetween. Feed/retentate screen 810 further includes blocking seal members 829 isolating gaps 827 from filtrate passageway 818. Blocking seal members 829 are formed from the sealant material being drawn into leg portions 814b and 814c and 816b and 816c of each feed/retentate aperture 814 and 816. Blocking seal members 829 thereby prevent gaps 827 from forming deadspots in the feed/retentate flow between apertures 820 and 822,

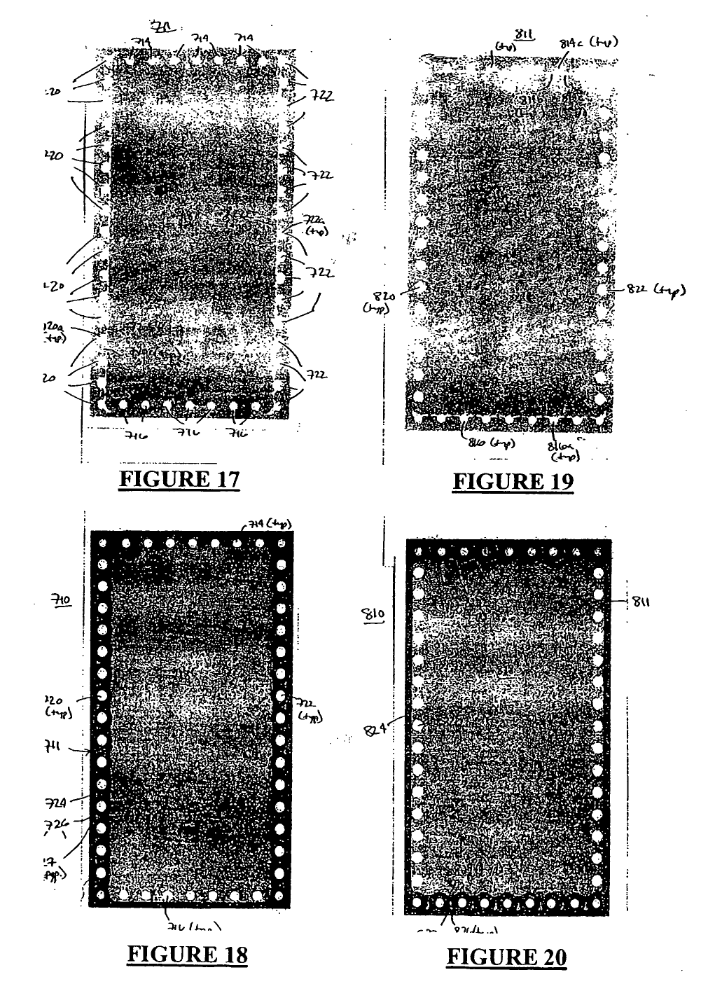

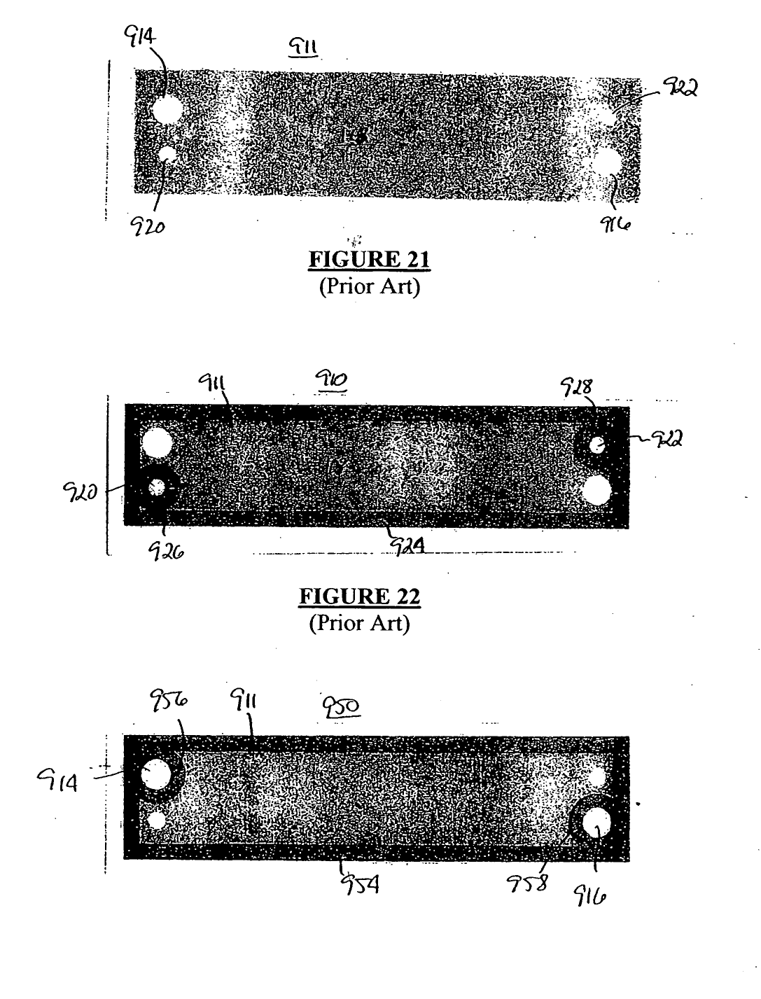

FIG. 21 depicts yet another screen for use in a filter cassette of the prior art. Screen die 911 is an elongate planar porous member defining first and second feed/retenate apertures 914 and 916, first and second filtrate apertures 920 and 922, and elongate passageway 918 therebetween. FIG. 22 depicts a sealed feed/retentate screen 910, formed by sealing screen die 911 for use in a feed/retentate subassembly of the prior art. Feed/retentate screen 910 incorporates a perimetrical seal 924 about screen die 911 and a first and second annular seal 926 and 928 about filtrate apertures 920 and 922, respectively. FIG. 23 depicts a sealed filtrate screen 950, formed by sealing screen die 911 for use in a filtrate subassembly of the prior art. Filtrate screen 950 incorporates a perimetrical seal 954 about screen die 911 and a first and second annular seal 956 and 958 about feed/retentate apertures 914 and 916, respectively.

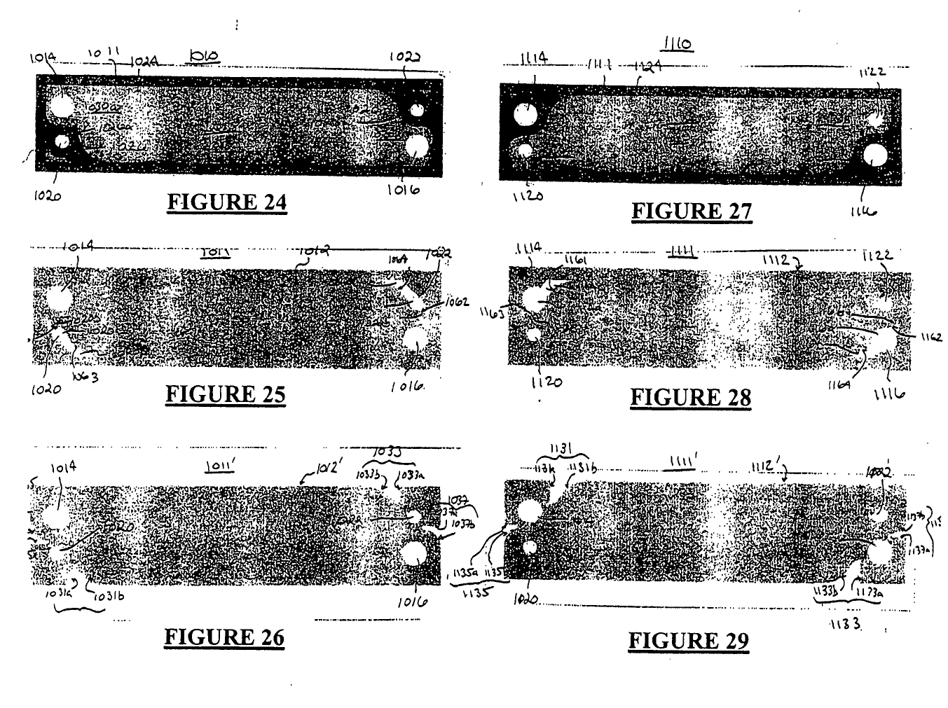

FIG. 24 depicts even still another sealed feed/retentate screen 1010 for use in a feed/retentate subassembly of the present invention. Feed/retenate screen 1010 includes an elongate porous planar body 1011 and a perimetrical seal 1024. Screen 1011 defines longitudinally-opposed and transversely-offset first and second feed/retentate apertures 1014 and 1016 and filtrate apertures 1020 and 1022. Feed/retentate screen 1011 further defines an elongate feed/retentate passageway 1018 extending between feed/retentate apertures 1014 and 1016. Perimetrical seal 1024 bounds passageway 1018 while filtrate apertures 1020 and 1022 are bounded by aperture seals 1026 which extend into passageway 1018 so as to define a feed/retentate channel 1030 exhibiting uniform flow without dead spots near the aperture seals. Aperture seals 1026 further define a smoothly tapered ends 1030a and 1030b for feed/retentate channel 1030 so as to further minimize the formation of deadspots in the cassette.

FIG. 25 depicts a filtrate screen die 1011 for use in forming sealed feed/retentate screen 1010 of the present invention. Feed/retentate screen 1011 incorporates a rectangular perimetrical edge 1012, circular feed/retentate apertures 1014 and 1016, and shaped filtrate apertures 1020 and 1022. Filtrate apertures 1020 and 1022 are asymmetrically-shaped apertures formed in accordance with the teachings of the present invention. Filtrate apertures 1020 and 1022 include circular portions 1020a and 1022a and substantially oppositely-extending portions 1020b, 1022b and 1020c,1022c, respectively. Portions 1020b, 1022b and 1020c, 1022c are partially defined by arcuate edges 1061, 1063, 1062 and 1064, respectively so as to impart the smoothly tapering leading edges 1026a to aperture seals 1026.

FIG. 26 depicts an alternate feed/retentate screen die 1011′ useful for forming sealed feed/retentate screen 1010. Feed/retentate screen die 1011′ incorporates a shaped perimetrical edge 1012′, circular feed/retentate apertures 1014 and 1016, and circular filtrate apertures 1020 and 1022 to assist in the formation of seals 1024 and 1026 thereabout. Shaped edge 1012′ defines a first and second of transversely-opening notch 1031 and 1033 at a location adjacent filtrate apertures 1020 and 1022, respectively. Each notch 1031 and 1033 includes linear edge 1031a and 1033a in facing opposition to an arcuate edge 1031b and 1033b, resepectively. Shaped edge 1012′ also defines a first and second longitudinally-opening notch 1035 and 1037 at locations longitudinally between adjacent apertures 1014,1020 and 1016, 1022, respectively. Each notch 1035 and 1037 includes linear edge 1035a and 1037a in facing opposition to an arcuate edge 1035b and 1037b, respectively. Arcuate edges 1031b, 1035b and 1033b, 1037b are desirably aligned to extend to either side of filtrate apertures 1020 and 1022, respectively. The aligned arcuate edges thereby allow the sealant material to flow into screen die 1011 and thereby provide a generally continuously tapering leading edge 1026a to each of the apertures seals 1026.

FIG. 27 depicts even still another sealed filtrate screen 1110 for use in a filtrate subassembly of the present invention. Filtrate screen 1110 includes an elongate porous planar body 1111 and a perimetrical seal 1124. Screen 1111 defines longitudinally-opposed and transversely-offset first and second feed/retentate apertures 1114 and 1116 and filtrate apertures 1120 and 1122. Feed/retentate screen 1111 further defines an elongate filtrate passageway 1118 extending between filtrate apertures 1120 and 1122. Perimetrical seal 1124 bounds passageway 1118 while feed/retentate apertures 1114 and 1116 are bounded by aperture seals 1126 which extend into passageway 1118 so as to define a filtrate channel 1130 exhibiting uniform flow without dead spots near the aperture seals. Aperture seals 1126 further define a smoothly tapered ends 1130a and 1130b for filtrate channel 1130 so as to further minimize the formation of deadspots in the cassette.

FIG. 28 depicts a filtrate screen die 1111 for use in forming sealed feed/retentate screen 1110 of the present invention. Filtrate screen 1111 incorporates a rectangular perimetrical edge 1112, circular filtrate apertures 1120 and 1122, and shaped feed/retenate apertures 1114 and 1116. Feed/retenate apertures 1114 and 1116 are asymmetrically-shaped apertures formed in accordance with the teachings of the present invention. Feed/retenate apertures 1114 and 1116 include circular portions 1114a and 1116a and substantially oppositely-extending portions 1114b, 1116b and 1114c, 1016c, respectively. Portions 1114b, 1116b and 1114c, 1016c are partially defined by arcuate edges 1161, 1163, 1162 and 1164, respectively so as to impart the smoothly tapering leading edges 1126a to aperture seals 1126.

FIG. 29 depicts an alternate filtrate screen die 1111′ useful for forming sealed filtrate screen 1110. Filtrate screen die 1111′ incorporates a shaped perimetrical edge 1112′, circular filtrate apertures 1120 and 1122, and circular feed/retentate apertures 1114 and 1116 to assist in the formation of seals 1124 and 1126 thereabout. Shaped edge 1112′ defines a first and second of transversely-opening notch 1131 and 1133 at a location adjacent feed/retentate apertures 1114 and 1116, respectively. Each notch 1131 and 1133 includes linear edge 1131a and 1133a in facing opposition to an arcuate edge 1131b and 1133b, resepectively. Shaped edge 1112′ also defines a first and second longitudinally-opening notch 1135 and 1137 at locations longitudinally between adjacent apertures 1114,1020 and 1116, 1122, respectively. Each notch 135 and 1137 includes linear edge 1135a and 1137a in facing opposition to an arcuate edge 1135b and 1137b, respectively. Arcuate edges 1131b, 1135b and 1133b, 1137b are desirably aligned to extend to either side of filtrate apertures 1120 and 1122, respectively. The aligned arcuate edges thereby allow the sealant material to flow into screen die 1111′ and thereby provide a generally continuously tapering leading edge 1126a to each of the apertures seals 1126.

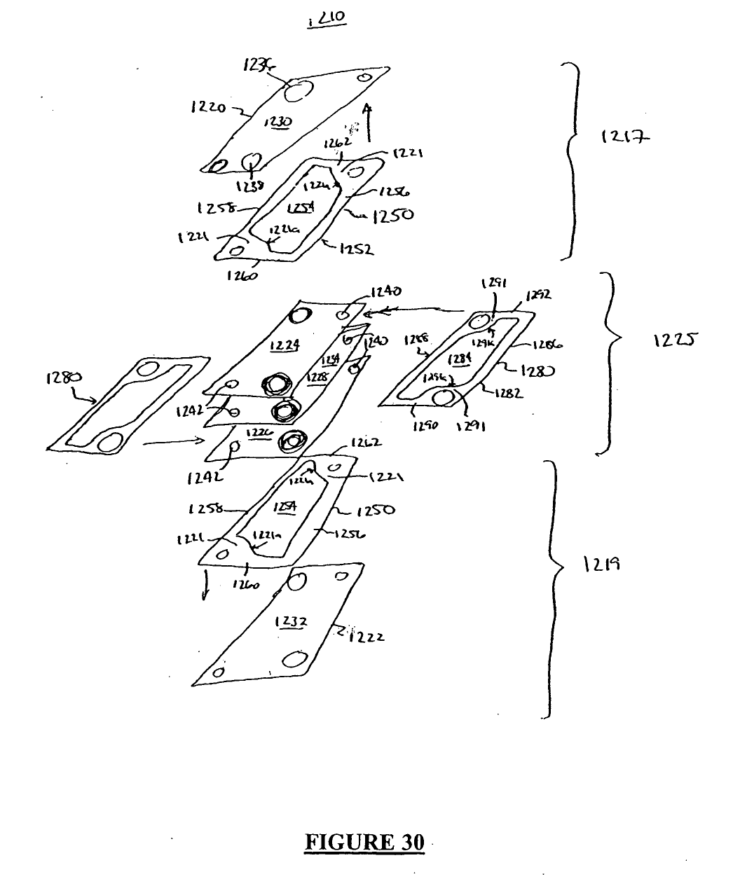

Referring now to FIG. 30, the present invention further contemplates that any of the shaped flow channels of the present invention may also be formed by positioning a gasket formed from a flowable material adjacent each screen of the finished cassette. FIG. 30 depicts an exploded view of a filtration cassette assembly 1210 of the present invention. The gaskets may take the form of stamped feed/retentate perform 1250 or stamped gasket filtrate perform 1280. Preforms 1250 and 1280 are desirably formed of a thermoset or thermoplastic material which may be heated so as to flow into the interstitial spaces of its associated screen and thereby both perimetrically seal the finished cassette as well as isolate the feed/retentate from filtrate streams internally thereto. The only communication between the feed/retentate and filtrate streams will occur through filter membranes 1224 and 1226. Preforms 1250 and 1280 may take the form of any of the perimetrical seals, aperture seals, and blocking seals disclosed by the present invention.

Cassette 1210 includes a first and second feed/retentate subassembly 1217 and 1219 and a filtrate subassembly 1225. Feed/retentate subassemblies 1217 and 1219 include an elongate porous feed/retentate screen 1220 and 1222, respectively, and a preform 1250. Filtrate subassembly 1225 includes first and second flat sheet filter membranes 1224 and 1226 positioned about filtrate screen 1228.

Preform 1250 includes an elongate planar body 1252 defining a central aperture 1254 positionable in registry with the elongate feed/retentate flow channels 1230 and 1232 of the feed/retentate screens 1220 and 1222 respectively. Preform 1250 includes a first and second transversely spaced segment 1256 and 1258 spanning between opposed first and second end segments 1260 and 1262. Aperture seals 1221 are provided to isolate the feed/retentate streams from the filtrate streams. Aperture seals 1221 include tapering leading edge 1221a extending into aperture 1252 so as to shape flow channel 1230 to taper towards feed/retentate apertures 1236 and 1238 and thereby thwart formation of deadspots in flow channels 1230 and 1232, consistent with the teaching of the present invention.

Similarly, preform 1280 includes an elongate planar body 1282 defining a central aperture 1284 positionable in registry with the flow channel 1234 of filtrate screen 1228. Preform 1280 includes a first and second transversely spaced segments 1286 and 1288 spanning between opposed first and second end segments 1290 and 1292. Aperture seals 1291 are provided to isolate the feed/retentate streams from the filtrate streams. Aperture seals 1291 include tapering leading edge 1291a extending into aperture 1282 so as to taper flow channel 1234 towards filtrate apertures 1240 and 1242 and thereby thwart formation of deadspots in flow channel 1234, consistent with the teaching of the present invention.

A cassette incorporating performs 1250 and 1280 may be formed by interlaying the respective filter screens, performs, and membranes and heating the assembly under compression so as to form the finished cassette. Dowels may be inserted through the registered apertures 1236, 1238, 1240, and 1242 so as to prevent the flowable perform material from flowing therein and blocking fluid flow therethrough in the finished filter cassette.

Alternatively, the flowable material may be provided by tracing a flowable gasketing material onto the screens in the generally desired shape of the final seals for each screen. Compression and heating of the flowable material will cause it to flow into and seal the adjacent screen layers as well as the porous filtration membranes.

While the preferred embodiment of the present invention has been shown and described, it will be obvious in the art that changes and modifications may be made without departing from the teachings of the invention. The matter set forth in the foregoing description and accompanying drawings is offered by way of illustration only and not as a limitation. For example, the present invention is not intended to be limited to the specific shapes of the apertures and notches disclosed herein. The actual scope of the invention is intended to be defined in the following claims when viewed in their proper perspective based on the prior art.

1. A filtration cassette comprising a first and second filtration media layer and a first, second, and third porous screen, said first and second screens defining a first and second feed/retentate passageway and said third screen defining a filtrate passageway, said first, second and third screens and said first and second filtration media layers each defining a plurality of feed/retentate apertures and filtrate apertures to be positioned in respective overlying registry so as to be in unobstructed fluid communication with the feed/retentate passageway and the filtrate passageway, respectively, the filtration cassette further comprising a sealing resin positioned about the filtration media and the screens in a manner to render the feed/retentate passageways in obstructed fluid communication with the filtrate passageways through said filter media, said sealing resin extending into said fluid passageways so as to define at least a portion of one fluid channel in each said passageway.

2. The filtration cassette of claim 1, wherein said sealing resin extends along the perimetrical edges and apertures of said feed/retentate and filtrate screens.

3. The filtration cassette of claim 1, wherein said sealing resin extends into said passageways so as to eliminate the formation of non-uniformities in fluid flow therethrough.

4. The filtration cassette of claim 1, wherein said screens define apertures shaped so as to positively direct the resin during vacuum drawing to a desired location in the flow channels.

5. The filtration cassette of claim 1, wherein said screen further includes a shaped perimetrical edge which also assists in the drawing of said flowable resin thereinto.

6. The filtration cassette of claim 1, wherein said feed/retentate apertures are shaped to be symmetrical only about the longitudinal axis of said filtrate screen.

7. The filtration cassette of claim 1, wherein said filtrate apertures are shaped to be symmetrical only about the longitudinal axis of said feed/retentate screen.

8. The filtration cassette of claim 1, wherein said feed/retentate apertures are shaped to be symmetrical only about three axes.

9. The filtration cassette of claim 1, wherein said filtrate apertures are shaped to be symmetrical only about three axes.

10. The filtration cassette of claim 1, wherein said feed/retentate apertures are shaped to be asymmetrical.

11. The filtration cassette of claim 1, wherein said filtrate apertures are shaped to be asymmetrical.
